(19) United States
(12) Patent Application Publication
(10) Pub. No.: US 2024/0303408 A1
(43) Pub. Date: Sep. 12, 2024

(54) METHOD AND SYSTEM FOR LEARNING-BASED SHAPING FLEXIBLE BLOCKS ON A CHIP CANVAS IN INTEGRATED CIRCUIT (IC) DESIGN

(71) Applicant: MEDIATEK Inc., Hsinchu City (TW)

(72) Inventors: Kun-Yu WANG, Hsinchu City (TW); Sheng-Tai TSENG, Hsinchu City (TW); Yi-Ying LIAO, Hsinchu City (TW); Jen-Wei LEE, Hsinchu City (TW); Ronald Kuo-Hua HO, Hsinchu City (TW); Bo-Jiun HSU, Hsinchu City (TW); Te-Wei CHEN, Hsinchu City (TW); Chun-Chih YANG, Hsinchu City (TW); Tai-Lai TUNG, Hsinchu City (TW)

(21) Appl. No.: 18/598,095

(22) Filed: Mar. 7, 2024

Related U.S. Application Data
(60) Provisional application No. 63/489,512, filed on Mar. 10, 2023.

(51) Int. Cl. G06F 30/392; G06F 111/04

(52) U.S. Cl. CPC G06F 30/392; G06F 2111/04

(57) ABSTRACT

The application discloses a method and a system for shaping flexible blocks on a chip canvas in an integrated circuit design. An input is received describing geometric features of flexible blocks. A set of flexible blocks are generated based on the input. Obtained block areas of the set of flexible blocks are computed. Whether the set of flexible blocks are legal is determined based on determining whether area differences between the obtained block areas and a plurality of required areas for the set of flexible blocks meet a requirement. The set of flexible blocks are updated until the set of flexible blocks are all legal.

This application claims the benefit of U.S. Provisional Application No. 63/489,512 filed on Mar. 10, 2023, the entirety of which is incorporated by reference herein.

### TECHNICAL FIELD

The disclosure relates in general to methods and systems for learning-based shaping flexible blocks on a chip canvas in an integrated circuit (IC) design and more particularly to methods and systems based on machine learning for shaping flexible circuit blocks with flexible aspect ratios on a semiconductor chip.

### BACKGROUND

Electronic Design Automation (EDA) tools are software applications that are used by electronic engineers and designers to design and analyze electronic systems. These tools play a crucial role in the development of integrated circuits (ICs), printed circuit boards (PCBs), and other electronic systems. EDA tools automate various tasks involved in the design process, making it more efficient and allowing designers to focus on higher-level aspects of the design.

Key functions and features of EDA tools include the follows.

(1) Schematic Capture: EDA tools allow designers to create schematic diagrams that represent the logical structure of the electronic system. This includes defining the relationships and connections between different components.

(2) Simulation: EDA tools enable simulation of electronic circuits to predict their behavior under different conditions. This helps designers identify potential issues and optimize the performance of the circuit before physical prototypes are built.

(3) Layout Design: EDA tools assist in the physical layout of components on a PCB or an IC. This involves placing and routing components to meet design specifications, considering factors like signal integrity and power distribution.

(4) Verification and Validation: EDA tools help verify the correctness of a design through various checks, such as design rule checking (DRC), layout versus schematic (LVS) checks, and electrical rule checking (ERC). This ensures that the design meets specified requirements and standards.

(5) Synthesis: In the context of digital design, synthesis tools convert high-level hardware description language (HDL) code into a netlist of logical gates or other components. This netlist is then used in subsequent stages of the design process.

(6) Timing Analysis: EDA tools analyze the timing characteristics of a design to ensure that signals meet required timing constraints. This is crucial in high-performance applications where timing issues can lead to functionality or reliability problems.

(7) Power Analysis: EDA tools help designers assess and optimize the power consumption of electronic systems. Power analysis is particularly important in battery-powered devices and energy-efficient applications.

(8) Manufacturability Analysis: EDA tools can perform checks and analyses to ensure that the design can be manufactured using available technology and processes. This includes considerations for yield, reliability, and manufacturing constraints.

EDA tools are widely used in industries such as semiconductor design, telecommunications, automotive electronics, and consumer electronics.

Floor planning is an early stage in integrated circuit (IC) design. During the floor-planning stage, circuit designers explore options for shaping flexible circuit blocks with flexible aspect ratios circuit blocks on a chip canvas.

In contemporary fixed-outline floorplan designs, the positioning of bounding boxes (BBoxes) within a canvas is essential to fulfill user specifications and to enhance power, performance, and area (PPA) optimization. BBox placement can be achieved using analytical methods or reinforcement learning (RL). Typically, a canvas includes blockage regions and/or pre-placed blocks, implying that the space available for accommodating flexible blocks is restricted. Consequently, there is a tendency for blocks to overlap, potentially resulting in area violations and congestion issues within the floorplan.

The block shaper plays a crucial role in the adjustment of obtained bounding boxes (BBoxes), aiming to rescale the bounding box and allocate overlapping areas, resulting in a rectilinear polygon block with a connected region that adheres to area requirements. Real-world implementations require blocks to exhibit a rectangle-like shape, avoiding zig-zag edges and adhering to predefined aspect ratios for efficient utilization in subsequent processes, such as macro placement. Unfortunately, addressing this design challenge proves exceptionally difficult, and the existing literature offers limited insights.

Mere expansion of BBox areas may not yield a valid solution for block shapes; therefore, alternative adjustments are necessary. Instead of enlarging BBoxes, dimensions (i.e., width and height, respecting aspect ratio constraints) are modified, and BBoxes are displaced from their initial placement to minimize overlapping regions between BBoxes. This ensures that the relative locations of BBoxes remain unchanged, thereby minimizing total displacement. This approach results in blocks with a rectangle-like shape, devoid of zig-zag edges, facilitating efficient utilization of block regions in subsequent processes like macro placement.

Considering wire length as a critical design metric for floorplanning, efforts are made to further minimize wire length, enhancing power, performance, and area (PPA) performance.

Leveraging convex optimization as a potent tool for addressing non-linear programming problems, the application proposes a convex approach aims to minimize overlapping between BBoxes and blockages based on the initial placement acquired through analytical methods or reinforcement learning (RL). Using a min-cost max-flow algorithm for a set of BBoxes, overlapping areas are allocated to obtain block shapes. If the block area falls short of requirements, an iterative process updates BBoxes using convex optimization with appropriate BBox areas, enhancing efficiency through the application of bisection.

### SUMMARY

According to one embodiment, a method of shaping flexible blocks on a chip canvas in an integrated circuit (IC) design is provided. The method comprises: receiving an input describing geometric features of a plurality of flexible blocks to be shaped on the chip canvas; generating a set of flexible blocks based on the input, and computing a plurality of obtained block areas of the set of flexible blocks; determining whether the set of flexible blocks are legal based on determining whether a plurality of area differences between the plurality of obtained block areas and a plurality of required areas for the set of flexible blocks meet a requirement; and when the set of flexible blocks are not all legal, updating the set of flexible blocks until the set of flexible blocks are all legal.

According to another embodiment, a system for shaping flexible blocks on a chip canvas in an integrated circuit (IC) design is provided. The system comprises: memory to store descriptions of the flexible blocks; and one or more processors coupled to the memory, at least one of the processors operative to perform operations of a neural network. The one or more processors are operative for: receiving an input describing geometric features of a plurality of flexible blocks to be shaped on the chip canvas; generating a set of flexible blocks based on the input, and computing a plurality of obtained block areas of the set of flexible blocks; determining whether the set of flexible blocks are legal based on determining whether a plurality of area differences between the plurality of obtained block areas and a plurality of required areas for the set of flexible blocks meet a requirement; and when the set of flexible blocks are not all legal, updating the set of flexible blocks until the set of flexible blocks are all legal.

### BRIEF DESCRIPTION OF THE DRAWINGS

The present invention is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one. Further, when a particular feature, structure, or characteristic is described in connection with an embodiment, it is submitted that it is within the knowledge of one skilled in the art to affect such feature, structure, or characteristic in connection with other embodiments whether or not explicitly described.

FIG. 1 is a block diagram illustrating reinforcement learning (RL) for flexible block shaping according to one embodiment.

FIG. 2 shows a block shaping method according to one embodiment of the application.

FIG. 3A shows initial placement of bounding boxes according to one embodiment of the application. Details of how to place the bounding boxes are not specified here.

FIG. 3B shows obtained block shapes from the block shaping according one embodiment of the application, where the values in blocks represent the difference (%) in area from the requirements.

FIG. 4 is a block diagram illustrating a system 400 operative to perform flexible block shaping according to one embodiment.

FIG. 5 shows an example of convex block shaping for floorplan algorithm according to one embodiment of the application.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DESCRIPTION OF THE EMBODIMENTS

Technical terms of the disclosure are based on general definition in the technical field of the disclosure. If the disclosure describes or explains one or some terms, definition of the terms is based on the description or explanation of the disclosure. Each of the disclosed embodiments has one or more technical features. In possible implementation, one skilled person in the art would selectively implement part or all technical features of any embodiment of the disclosure or selectively combine part or all technical features of the embodiments of the disclosure.

In the following description, numerous specific details are set forth. However, it is understood that embodiments of the invention may be practiced without these specific details. In other instances, well-known circuits, structures, and techniques have not been shown in detail in order not to obscure the understanding of this description. It will be appreciated, however, by one skilled in the art, that the invention may be practiced without such specific details. Those of ordinary skill in the art, with the included descriptions, will be able to implement appropriate functionality without undue experimentation.

In embodiments of the application, a learning-based neural network is described for shaping flexible blocks on a chip canvas in an integrated circuit (IC) design process. The term “flexible block” as used herein refers to a circuit block that has a fixed area and a flexible shape. In one embodiment, the shape is defined by an aspect ratio, which is the ratio of width to height of a rectangle. When shaping a flexible block, a block shaping tool that uses the neural network not only determines the shape of the flexible circuit block. The block shaping tool may be part of an electronic design automation (EDA) tool.

In one embodiment, for example, a flexible block may be a proprietary intellectual property (IP) core; e.g., a hardware subsystem (microprocessor, controller, universal serial bus (USB), image processor, etc.). Automating the floor planning and shaping of flexible blocks can significantly shorten the time spent on design exploration and the overall IC design process. For example, a block shaping tool based on a reinforcement-learning (RL) neural network can shape hundreds of flexible blocks with reasonable quality. The increased shaping speed allows a circuit designer to explore more design choices within a limited design time frame.

Alternatively, a flexible block may be an RTL-coded circuit module or a post-synthesized circuit module such as a macro (e.g., a memory circuit such as static random access memory (SRAM)). Thus, shaping of flexible blocks described herein may be performed in any stage of an IC design process including an early exploration stage of floor planning and a post-synthesis stage.

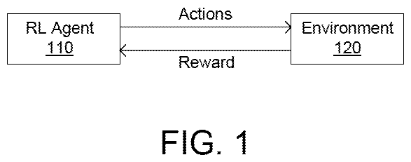

FIG. 1 is a block diagram illustrating reinforcement learning (RL) for flexible block shaping according to one embodiment. An RL agent 110 receives an input including a state of a chip canvas and a description of a flexible block (whose placement is fixed) to be shaped on the chip canvas. RL agent 110 performs neural network operations on the input and outputs an action for placing the flexible block. After all of the flexible blocks are shaped, the final state of the canvas (also referred to as a floorplan) is evaluated by an environment 120 to produce a reward. The reward may include an estimate of wirelength, congestion, etc. The operations of environment 120 may be performed by a computing system. The evaluation result from the environment 120 is fed back to the RL agent 110 to adjust its parameters and/or to determine whether to continue the reinforcement learning process. In one embodiment, environment 120 may also generate action masks that block out areas of the chip canvas for RL agent 110 to generate the actions.

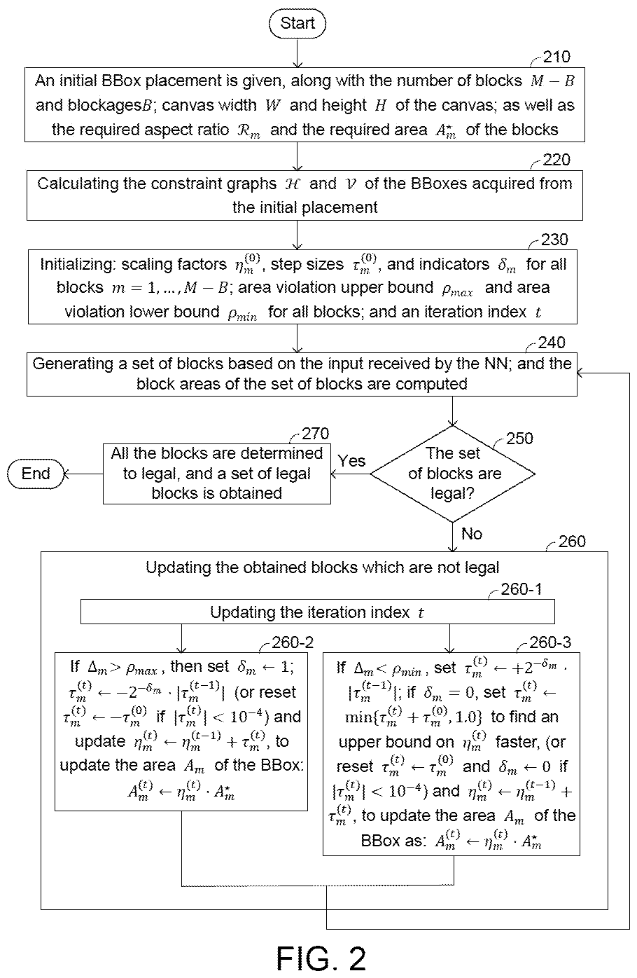

FIG. 2 shows a block shaping method according to one embodiment of the application.

In step 210, an initial BBox placement is given, along with the number of blocks M-B and blockagesB; canvas width W and height H of the canvas; as well as the required aspect ratio [symbol] ₘ and the required area Aₘ* of the blocks. In general, step 210 is to initialize the parameters (including the block number “M-B” of the blocks, the blockage number “B” of the blockages; the canvas width W and height H of the canvas; the respective required aspect ratio [symbol] ₘ and area Aₘ* of the blocks (m=1, . . . , M-B).

In step 220, the constraint graphs [symbol] and [symbol] of the BBoxes acquired from the initial placement in step 210 are calculated. In general, step 220 is also to initialize the parameter (i.e. the constraint graphs [symbol] and [symbol] ).

In step 230, the following parameters are initialized or set: scaling factors ηₘ⁽⁰⁾, step sizes τₘ⁽⁰⁾, and indicators δₘ for all blocks m=1, . . . , M-B; area violation upper bound ρₘₐₓ and area violation lower bound ρₘᵢₙ for all blocks; and an iteration index t. For example, but not limited by, in step 230, the parameters are initialized or set as: the initial scaling factor ηₘ⁽⁰⁾ is set as 1 (ηₘ⁽⁰⁾←1); the initial step size τₘ⁽⁰⁾ is set as 0.1 (τₘ⁽⁰⁾←0.1); the indicator δₘ is set as 0 for all blocks m=1, . . . , M-B(δₘ←0 for all blocks m=1, . . . , M-B); the area violation upper bound ρₘₐₓ is set as 10⁻² (ρₘₐₓ←10⁻²) for all blocks; the area violation lower bound ρₘₐₓ is set as −10⁻² (ρₘᵢₙ←−10⁻²) for all blocks; and the iteration index t is set as 0 (t←0).

In practice, in the steps 210-230, a neural network (NN) receives an input describing a given initial BBox placement, along with the number of blocks M-B and blockages B; canvas width W and height H of the canvas; as well as the required aspect ratio [symbol] ₘ and the required area Aₘ* of the blocks. Further, the input received by the neural network (NN) describing the scaling factors, the step sizes, and the indicators for all blocks m=1, . . . , M-B; an area violation upper bound ρₘₐₓ and an area violation lower bound ρₘᵢₙ for all blocks; and an iteration index.

In step 240, an objection function (which is for example but not limited by, the below equation (7)) is solved to generate a set of blocks based on the input received by the NN; and the block areas Âₘ of the set of blocks are computed. Details of the objection function are descried later.

In step 250, whether the set of blocks are legal are determined. In details, for example but not limited by, whether the set of blocks are legal are determined based on whether both Δₘ [symbol] (Âₘ−Aₘ*)/Aₘ*←ρₘₐₓ and Δₘ≥ρₘᵢₙ hold for all m=1, . . . , M-B, wherein Âₘ is the obtained block area of the mth block m; and Aₘ* is the required area of the mth block, Δₘ refers to the difference between the obtained block area and the required area of the mth block. In other words, in step 250, whether the difference between the obtained block area and the required area for all blocks is smaller than the area violation upper bound ρₘₐₓ but larger than the area violation lower bound ρₘᵢₙ are determined. When the difference between the obtained block area and the required area for all blocks is smaller than the area violation upper bound ρₘₐₓ but larger than the area violation lower bound ρₘᵢₙ, then the obtained blocks are determined to be legal. If no, step 260 is iterated until the obtained blocks are determined to be legal.

In step 260, the obtained blocks which are not legal are updated. Step 260 is performed all blocks m=1, . . . , M-B are legal. Step 260 includes three sub-steps 2660-1-260-3.

In the first sub-step 260-1 of the step 260, the iteration index t is updated, for example but not limited by, t←t+1.

In the second sub-step 260-2 of the step 260, if Δₘ>ρₘₐₓ, then set δₘ←1; τₘ^{(t)}←−2^{-δ}^{ₘ}·|τₘ^{(t-1)}| (or reset τₘ^{(t)}←−τₘ⁽⁰⁾) if |τₘ^{(t)}|10⁻⁴) and update ηₘ^{(t)}←ηₘ^{(t-1)}+ηₘ^{(t)}. Thus, in the sub-step 260-2, the area Aₘ of the BBox is updated as: Aₘ^{(t)}←ηₘ^{(t)}·Aₘ*. That is, in the sub-step 260-2, when the area difference of the flexible block is larger than the area violation upper bound (Δₘ>ρₘₐₓ), setting the indicator (δₘ←1), updating or resetting the step size (updating the step size τₘ^{(t)}←−2^{-δ}^{ₘ}·|τₘ^{(t-1)}|, or resetting the step size τₘ^{(t)}←−τₘ⁽⁰⁾ if |τₘ^{(t)}|<10⁻⁴), and updating the scaling factor (ηₘ^{(t)}←ηₘ^{(t-1)}+τₘ^{(t)}) to update the area of the flexible block Aₘ^{(t)}←ηₘ^{(t)}·Aₘ*.

In the third sub-step 260-3 of the step 260, if Δₘ<ρₘᵢₙ, set τₘ^{(t)}←+2^{-δ}^{ₘ}·|τₘ^{(t-1)}|; if δₘ=0, set τₘ^{(t)}←min{τₘ^{(t)})+τₘ⁽⁰⁾, 1.0} to find an upper bound on ηₘ^{(t)}) faster, (or reset τₘ^{(t)}←τₘ⁽⁰⁾ and δₘ←0 if |τₘ^{(t)}|<10⁻⁴) and ηₘ^{(t)}←ηₘ^{(t-1)}+τₘ^{(t)}. Thus, in the sub-step 260-3, the area Aₘ of the BBox is updated as: Aₘ^{(t)}←ηₘ^{(t)}·Aₘ*. That is, in the sub-step 260-3, when the area difference of the flexible block is smaller than the area violation lower bound (Δₘ<ρₘᵢₙ), setting the indicator (δₘ←0), updating or resetting the step size (τₘ^{(t)}←+2^{-δ}^{ₘ}·|τₘ^{(t-1)}|; if δₘ=0, set τₘ^{(t)}←min{τₘ^{(t)}+τₘ⁽⁰⁾, 1.0} to find an upper bound on ηₘ^{(t)} faster, (or reset τₘ^{(t)}←τₘ⁽⁰⁾ and δₘ=0 if |τₘ^{(t)}|<10⁻⁴)), and updating the scaling factor (ηₘ^{(t)}←ηₘ^{(t-1)}+τₘ^{(t)}) to update the area of the flexible block Aₘ^{(t)}←ηₘ^{(t)}·Aₘ*.

After the step 260 is performed, the flow returns to the step 240.

In step 270, all the blocks are determined to legal, and a set of legal blocks is obtained.

Details of the steps 210-270 of the block shaping method according to one embodiment of the application are described.

How to generate a set of flexible blocks are described below.

One embodiment of the application considers a canvas with “M-B” blocks and “B” blockages, spanning a width W and height H of the canvas, wherein M and B are both positive integers. The initial BBox placement involves rectangle-shaped bounding boxes (BBoxes) acquired through an analytical approach or reinforcement learning (RL), and these BBoxes may exhibit overlaps with each other and/or with blockages. One embodiment of the application has an objective to transform these BBoxes into rectilinear polygon blocks that fulfill the following criteria: (i) non-overlapping; (ii) meeting required block areas; (iii) adhering to specified aspect ratios; (iv) forming a connected block region; and (v) exhibiting a rectangle-like shape without zig-zag edges. For conciseness, blocks satisfying these five criteria are referred as “legal blocks.”

For each block, it is necessary to generate a BBox, representing a minimum area rectangle capable of accommodating the rectilinear polygon block. The mth (“m” being also a positive integer (m=1, . . . , M-B)) BBox, obtained from the placer, is centered at coordinates (x̅m, y̅ₘ) and possesses width wₘ and height hₘ. The required area of the m-th block is denoted as Aₘ*, while the associated BBox area is expressed as Aₘ [symbol] wₘ×hₘ. Additionally, horizontal and vertical constraint graphs ( [symbol] and [symbol] , respectively) can be constructed based on the initial BBox placement.

### Convex Formulation and Algorithms

The block-shaping designs may be formulated as a tractable convex optimization problem. This formulation allows for efficient resolution using standard solvers, enabling to achieve the globally optimal solution.

In the pursuit of legal block shapes, the initial step involves defining the bounding boxes (BBoxes). These BBoxes must reside within the canvas, and their dimensions, denoted by width wₘ and height hₘ, must satisfy the equation wₘ×hₘ=Aₘ, along with adhering to the pre-defined aspect ratio [symbol] ₘ. To render the non-convex area constraint wₘ×hₘ=Aₘ into a convex form, the constraint is relaxed to wₘ×hₘ≥Aₘ. With simple calculations, the following formula (1) is obtained:

$${h}_{m} + {w}_{m} \geq ‖ [ {h}_{m} - {w}_{m} , 2 \times \sqrt{{A}_{m}} ] ‖ \qquad ( 1 )$$

In the formula (1), ∥·∥ denotes Euclidean norm. The formula (1) is a constraint, which is a second-order cone and thus convex. This reformulation guarantees that the equality is satisfied at the optimal solution (i.e., wₘ*×hₘ*=Aₘ), thereby achieving a relaxation with zero gap from the optimal solution.

In one embodiment of the application, the optimization problem aims to minimize the total BBox displacement from the initial placement, while keeping the relative positions between blocks and blockages unchanged, in order to maintain the performance (e.g., wire length) acquired from the placement stage. Furthermore, the overlapping quantities between blocks and blockages are minimized, which can ensure more rectangle-like block shapes. To make the blocks even more square-like, minimizing the perimeter of each BBox is considered in one embodiment of the application. Minimizing wire length can improve power, performance, and area (PPA), and thus, wire length minimization is taken into the optimization problem as well in one embodiment of the application.

For the purpose of wire length minimization, half-perimeter wire length (HPWL) is taken as the objective for designing BBoxes. Given a set of nets (i.e., hyperedges) [symbol] (i.e., netlist), the HPWL of net e is defined as:

$${HPWL}_{e} {=}^{△} {max}_{i , j ∈ e} \vert {x}_{i} - {x}_{j} \vert + {max}_{i , j ∈ e} \vert {y}_{i} - {y}_{j} \vert \qquad ( 1.1 )$$

Whenever the edge (i,j) is present in e, the edge (j,i) must also be presented in e. The goal is to minimize the total HPWL of all the nets e∈ [symbol] i.e.,

$${min}_{x , y} {\sum }_{e ∈ 𝔼} {HPWL}_{e} . \qquad ( 2 )$$

If HPWLₑ in equation (2) can be formulated as a convex function, then equation (2) is a convex problem. By expressing HPWLₑ as tₑₓ+t_{ey}, where

$${t}_{ex} = {max}_{i , j ∈ e} \vert {x}_{i} - {x}_{j} \vert and {t}_{ey} = {max}_{i , j ∈ e} \vert {y}_{i} - {y}_{j} \vert , \qquad ( 3 )$$

min_{xy} HPWLₑ can be equivalently represented as

$${min}_{x , y , {t}_{ex} , {t}_{ey}} {t}_{ex} + {t}_{ey} \qquad ( 4 )$$

The formula (4) is subject to

$${t}_{ex} \geq {max}_{i , j ∈ e} \vert {x}_{i} - {x}_{j} \vert and {t}_{ey} \geq {max}_{i , j ∈ e} \vert {y}_{i} - {y}_{j} \vert . \qquad ( 5 )$$

Both tₑₓ*=max_{i,j∈e}|xᵢ*−xⱼ*| and t_{ey}*=max_{i,j∈e}|yᵢ*−yⱼ*| must be achieved at the optimal solution, and so the equality constraints in equation (3) is relaxed to the inequality constraints (5). The constraints in equation (5) can be further equivalently written by

$${t}_{ex} \geq \vert {x}_{i} - {x}_{j} \vert and {t}_{ey} \geq \vert {y}_{i} - {y}_{j} \vert , ∀ i , j ∈ e . \qquad ( 6 )$$

The objective function in (4) is convex, and the constraint set in (6) is also convex, so problem (i.e. minimize the total HPWL of all the nets) in the formula (2) can be solved efficiently to obtain the optimal solution.

### Convex Formulation

Given a set of BBox area Aₘ, the optimization problem for finding the set of BBoxes is expressed in the formula (7) which is convex and thus can be efficiently solved by off-the-shelf convex optimization software.

Formula (7) is listed in below, which contains formula (7.1)-(7.10). Formula (7), i.e. formulas (7.1)-(7.10) is used to generate the set of flexible blocks in the step 240.

$${min}_{\{ {x}_{m} , {y}_{m} , {w}_{m} , {h}_{m} , {δ}_{mn}^{x} , {δ}_{mn}^{y} , {t}_{ex} , {t}_{ey} \}} {α}_{1} \cdot {C}_{DISP} ( x , y ) + {α}_{2} \cdot {C}_{OVLP} ( {δ}^{x} , {δ}^{y} ) + {α}_{3} \cdot {C}_{PERI} ( w , h ) + {α}_{4} \cdot {C}_{HPWL} ( {t}_{x} , {t}_{y} ) \qquad ( 7.1 )$$

$$s . t . {w}_{m} / 2 \leq {x}_{m} \leq W - {w}_{m} / 2 , ∀ m = 1 , … , M - B , \qquad ( 7.2 )$$

$${h}_{m} / 2 \leq {y}_{m} \leq H - {h}_{m} / 2 , ∀ m = 1 , … , M - B , \qquad ( 7.3 )$$

$${x}_{n} - {x}_{m} \geq ( {w}_{m} + {w}_{n} ) / 2 - {τ}_{mn}^{x} \cdot {δ}_{mn}^{x} , ∀ m \to n ∈ ℋ , \qquad ( 7.4 )$$

$${y}_{n} - {y}_{m} \geq ( {h}_{m} + {h}_{n} ) / 2 - {τ}_{mn}^{y} \cdot {δ}_{mn}^{y} , ∀ m \to n ∈ 𝒱 , \qquad ( 7.5 )$$

$${δ}_{mn}^{x} \geq 0 and {δ}_{mn}^{y} \geq 0 , ∀ m , n = 1 , … , M , \qquad ( 7.6 )$$

$${h}_{m} \leq {ℛ}_{m} \times {w}_{m} and {w}_{m} \leq {ℛ}_{m} \times {h}_{m} , ∀ m = 1 , … , M - B , \qquad ( 7.7 )$$

$${h}_{m} + {w}_{m} \geq ‖ [ {h}_{m} - {w}_{m} , 2 \times \sqrt{{A}_{m}} ] ‖ , ∀ m = 1 , … , M - B , \qquad ( 7.8 )$$

$${h}_{m} > 0 and {w}_{m} > 0 , ∀ m = 1 , … , M - B , \qquad ( 7.9 )$$

$${t}_{ex} \geq \vert {x}_{m} + {w}_{m} / 2 - ( {x}_{n} - {w}_{n} / 2 ) \vert and {t}_{ey} \geq \vert {y}_{m} + {h}_{m} / 2 - ( {y}_{n} - {h}_{n} / 2 ) \vert , ∀ m , n ∈ e and ∀ e ∈ 𝔼 . \qquad ( 7.1 )$$

In the formula (7), the variables are defined as below. xₘ and yₘ are the center of the mth BBbox; wₘ and hₘ are the width and the height of the mth BBox; δₘₙ^{x} and δₘₙ^{x} are the overlapping quantities between the mth block and nth block. tₑₓ, t_{ey} are the HPWL involved variables.

The formula (7), which is an objective function, contains four cost functions to represent the total BBox displacement c_{DISP}(x,y) from initial BBox placement:

$${C}_{DISP} ( x , y ) {=}^{△} {\sum }_{m = 1}^{M - B} \vert {x}_{m} - {\overline{x}}_{m} \vert + \vert {y}_{m} - {\overline{y}}_{m} \vert , \qquad ( 8 )$$

The total overlapping quantities C_{OVLP}(δ^{x}, δ^{y}) among BBoxes and blockages is below:

$${C}_{OVLP} ( {δ}^{x} , {δ}^{y} ) {=}^{△} {\sum }_{m , n = 1}^{M} {δ}_{mn}^{x} + {δ}_{mn}^{y} , \qquad ( 9 )$$

The half perimeters C_{PERI}(w,h) of BBoxes is represented as:

$${C}_{PERI} ( w , h ) {=}^{△} {\sum }_{m = 1}^{M} {w}_{m} + {h}_{m} , \qquad ( 10 )$$

The total HPWL C_{HPWL}(tₓ,t_{y}) of the BBoxes is represented as:

$${C}_{HPWL} ( {t}_{x} , {t}_{y} ) {=}^{△} {\sum }_{e ∈ 𝔼} {t}_{ex} + {t}_{ey} . \qquad ( 11 )$$

It is important to note that (δ_{n,m}^{x})*×(δ_{n,m}^{y})*=0 must be satisfied at the optimal point. This ensures that the overlapping quantity of a BBox with others can be minimized in a direction (according to the horizontal and vertical constraint graphs [symbol] and [symbol] ).

The boundary constraints of the canvas are given in formulas (7.2) and (7.3). That is, in formulas (7.2) and (7.3), the X center coordinate xₘ of the mth bounding box is between wₘ/2≤xₘ≤W −wₘ/2; and the Y center coordinate yₘ of the mth bounding box is between hₘ/2≤yₘ≤H −hₘ/2. By formulas (7.2) and (7.3), the BBoxes are limited to be located within the canvas. In other words, formulas (7.2) and (7.3) constrain a first center coordinate of a bounding box based on a width of the bounding box and the canvas width; and constrain a second center coordinate of the bounding box based on a height of the bounding box and the canvas height, wherein the bounding box is constrained to be located within the chip canvas.

Equations (7.4) and (7.5) specify the overlapping constraints of the BBox. In details, by xₙ−xₘ≥(wₘ+wₙ)/2−τₘₙ^{x}·δₘₙ^{x}, the blocks are not overlapped in X-direction; and similarly, by yₙ−yₘ≥(hₘ+hₙ)/2−τₘₙ⁷·δₘₙ⁷, the blocks are not overlapped in Y-direction. τₘₙ^{x} and τₘₙ^{y} are not variables. In other words, equations (7.4) and (7.5) specify overlapping constraints of a plurality of bounding boxes by constraining differences (xₙ−xₘ) between a plurality of first center coordinates of the bounding boxes based on widths of the bounding boxes (wₘ, wₙ) and first overlapping quantities (τₘₙ^{y}) and constraining differences (yₙ−yₘ) between a plurality of second center coordinates of the bounding boxes based on heights (hₘ, hₙ) of the bounding boxes and second overlapping quantities (τₘₙ^{y}).

Equation (7.6) denotes the constraints about the overlapping quantities δₘₙ^{x} and δₘₙ^{y}. The overlapping quantities δₘₙ^{x} and δₘₙ^{y} measure the distances of overlap along the x and y axes, respectively, as defined in equations (7.4) and (7.5), and values of the overlapping quantities δₘₙ^{x} and δₘₙ^{y} are always positive.

Equations (7.7) and (7.8) denote the constraints about the aspect ratio [symbol] m and the area Aₘ of the BBox, respectively. For example, via equation (7.7), the aspect ratio [symbol] m of the BBox is limited within a predetermined range ((hₘ≤ [symbol] m×wₘ) and (wₘ≤ [symbol] ₘ×hₘ)). Further, the BBox is better to be more like rectangular, neither too wide nor too high. The equation (7.7) also refers to that:

$$( ( \frac{{h}_{m}}{{w}_{m}} ) \leq {ℛ}_{m} ) and ( ( \frac{{w}_{m}}{{h}_{m}} ) \leq {ℛ}_{m} ) .$$

Equation (7.7) is rewritten into equation (7.8) for better proceeding by the disclosed algorithm.

Equation (7.9) denotes the constraints about the height hₘ and the width wₘ of the BBox, respectively. That is, the height hₘ and the width wₘ of the BBox have to be larger than 0.

Equation (7.10) expresses the HPWL constraints. In addition, for constraints (7.4) and (7.5), the constants τₘₙ^{x} and τₘₙ^{y} are defined based on widths Wₘ, Wₙ and heights Hₘ, Hₙ of the initial BBoxes m and n.

$${τ}_{mn}^{x} ← 1 - {φ}_{mn}^{x} \times sign ( \vert {\overline{y}}_{m} - {\overline{y}}_{n} \vert < 0.5 \times ( {H}_{m} + {H}_{n} ) ) and \qquad ( 11.1 )$$

$${τ}_{mn}^{y} ← 1 - {φ}_{mn}^{y} \times sign ( \vert {\overline{x}}_{m} - {\overline{x}}_{n} \vert < 0.5 \times ( {W}_{m} + {W}_{n} ) ) ,$$

In the formula (11.1), sign(True) [symbol] 1 and sign(False) [symbol] 0. For example, when (|y̅ₘ−y̅ₙ|<0.5×(Hₘ+Hₙ)) is true, sign(|y̅ₘ−y̅ₙ|<0.5×(Hₘ+Hₙ)) is 1; and when (|y̅ₘ−y̅ₙ|<0.5×(Hₘ+Hₙ)) is false, sign(|y̅ₘ−y̅ₙ|<0.5×(Hₘ+Hₙ)) is 0.

The values of φₘₙ^{x} and φₘₙ^{y} ∈[0,1] can be used to control the amount of overlap between a BBox and other BBoxes or blockages. The larger the values of φₘₙ^{x} and φₘₙ^{x}, the less overlap there will be between the BBox and others. In one experiment, the followings are set: φₘₙ^{x}=φₘₙ^{y} to 0.8 for both m,n∈{1, . . . , M-B} and to 0 otherwise, for optimal results.

Note that the design variables {xₘ, yₘ, wₘ, hₘ} involve only blocks (excluding blockages), with m=1, . . . , M-B. Since the objective function aims to minimize δₘₙ^{x} and δₘₙ^{y}, it does not favor increasing δₘₙ^{x} and δₘₙ^{y} for m,n∈{1, . . . , M-B} with overlapped on both x-axis and y-axis, and so the amount of overlap between the BBoxes should be kept to a minimum.

In one embodiment of the application, the reason to modify the BBox area Aₘ is described below.

### Overlapping Area Assignment

Once the BBoxes have been acquired from the formula (7), max-flow algorithms may be used to evaluate whether the blocks contained in each BBox can meet the required areas. If it is not possible, then the overlapping area must be assigned to the right or top BBox (as determined by the constraint graphs [symbol] and [symbol] ). On the other hand, if the max-flow algorithm proves to be feasible, then overlapping regions can be allocated based on min-cost criteria in order to obtain the blocks. Ultimately, this helps to find the most efficient way to accomplish the required areas.

Whenever the obtained block area Âₘ does not match the desired area Aₘ*, the BBox area Aₘ needs to be modified so that Âₘ=Aₘ*. This can be efficiently accomplished by performing a bisection on Aₘ [symbol] αₘ−Aₘ* (or more specifically, on αₘ), where αₘ≥1 and successively solving the relevant convex formula (7). The scale αₘ should be updated according to Âₘ. The initial value of αₘ⁽⁰⁾ is set to 1.

In one embodiment of the application, details of updating Bounding Box (i.e. details about steps 250 and 260) are as below.

Formula (7) for given BBox areas {Aₘ} is solved and Aₘ is adjusted based on the difference between the obtained non-overlapping area Âₘ and the required area Aₘ*. Specifically, the scaling factor is updated as ηₘ^{(t+1)}←ηₘ^{(t)}+τₘ^{(t+1)} and the BBox area Aₘ is updated as: Aₘ^{(t+1)}←ηₘ^{(t+1)}, which is to update the area Aₘ of the BBox in the sub-steps 260-2 and 260-3. Also, Aₘ* for formula (7) only when Âₘ≠Aₘ*. Aₘ^{(O)} is defined as Aₘ⁽⁰⁾ [symbol] Aₘ* ηₘ⁽⁰⁾←1, and a step size τₘ^{(t+1)} that is positive for Âₘ<Aₘ* or negative for Âₘ>Aₘ*, for all time index t≥0. For example, a relatively large initial value is set for τₘ⁽⁰⁾←0.1, which corresponds to a maximum step size of 10% of the required area of block m in the bisection algorithm. This can help to speed up the process of finding an upper bound on η_{m.}

Since formula (7) is a non-decreasing function from input Aₘ to output Âₘ, time-efficient bisection search is used to find the optimal ηₘ for Aₘ so that Âₘ=Aₘ* holds. To this end, an upper bound on ηₘ is acquired by using line search on τₘ, such that Âₘ>Aₘ* is true. Once an upper bound ηₘ^{(t+1)} is found, ηₘ^{(t)}) should serve as a lower bound so that Âₘ<Aₘ* is true. The optimal ηₘ^{(T)} for T>t+1 such that Âₘ=Aₘ* is fulfilled can then be quickly identified through bisection search between the bounds. More specifically, ηₘ^{(t+2)} is updated by ηₘ^{(t+2)}=(ηₘ^{(t+1)}+ηₘ^{(t)}/2, which can be implemented by setting ηₘ^{(t+2)}←ηₘ^{(t+1)}−2⁻¹×τₘ^{(t+1)} and it should be noted that τₘ^{(t+1)}=τₘ⁽⁰⁾. Afterwards, the step size will be reduced by half (i.e., τₘ^{(t+1)}=τₘ^{(t)}, with the sign determined based on the values of Âₘ^{(T)} and Aₘ*.

Assuming that the upper and lower bounds on ηₘ are determined by line search at time t+1, the difference between the bounds should be 2^{-N}×(ηₘ^{(t+1)}−ηₘ^{(t)}) at the N th bisection iteration. To declare that the bisection has converged, it must ensure that 2^{-N}×(ηₘ^{(t+1)}−ηₘ^{(t)})≤ε for some small value ε>0. Thus, the total number N of bisection iterations should be:

$$N = ⌈ {log}_{2} ( ( {η}_{m}^{( t + 1 )} - {η}_{m}^{( t )} ) / ε ) ⌉ . \qquad ( 12 )$$

To illustrate the efficiency of bisection, the case where ηₘ^{(t+1)}−ηₘ^{(t)})=τₘ⁽⁰⁾ [symbol] 0.1 and ε [symbol] 10⁻⁴ is considered. Based on the formula (12), the bisection iteration should be N=10, while line search requires around N=1000 iterations in the worst case.

Since the block shapes can change over time, the current upper bound ηₘ^{(t+1)} might not be accurate for later times T>t+1. This means that Âₘ>Aₘ* holds at t+1 but Âₘ<Aₘ* at time T, resulting in |τₘ^{(t)}| becoming very small.

Under this situation, τₘ^{(T+1)} is reset as τₘ^{(T+1)}←±τₘ⁽⁰⁾ with the sign determined based on the values of Âₘ^{(T)} and Aₘ*.

In summary, the block shaping method in FIG. 2 of the embodiment of the application, the steps 210-230 initialize the parameters. On Steps 240-250, the BBoxes are iteratively updated. For a given set of BBox areas Aₘ, for m=1, . . . , M-B, problem (7) is solved on the step 240 and then a bisection search is run on the step 260. The block shaping method of FIG. 2 terminates when a set of legal blocks is found (i.e. all legal blocks “M-B” are found).

Theoretically, the convex optimization formula (7) must be feasible with proper BBox areas Aₘ, for m=1, . . . , M-B, due to the introduction of overlapping quantities δₘₙ^{x} and δₘₙ^{y}. However, it is important to note that achieving legal blocks is not guaranteed, and the outcome depends heavily on the initial placement of the BBoxes, such as their relative locations. In experiments, it is usually able to obtain legal blocks through initial BBox placement.

In one embodiment of the application, the performance of the proposed block shaping method for a floorplan is evaluated. To do so, the block shapes are demonstrated; and the wire length, and runtime of the proposed method are compared to those of a prior art (for example a commercial EDA tool).

It aims to adjust the BBoxes for obtaining legal blocks, using the proposed method in one embodiment of the application. The aspect ratio [symbol] ₘ is set to 2 for all BBoxes in experiments. Additionally, the weighting factors in (7.1) are set to α₁=α₃←1 and α₂=α₄←10.

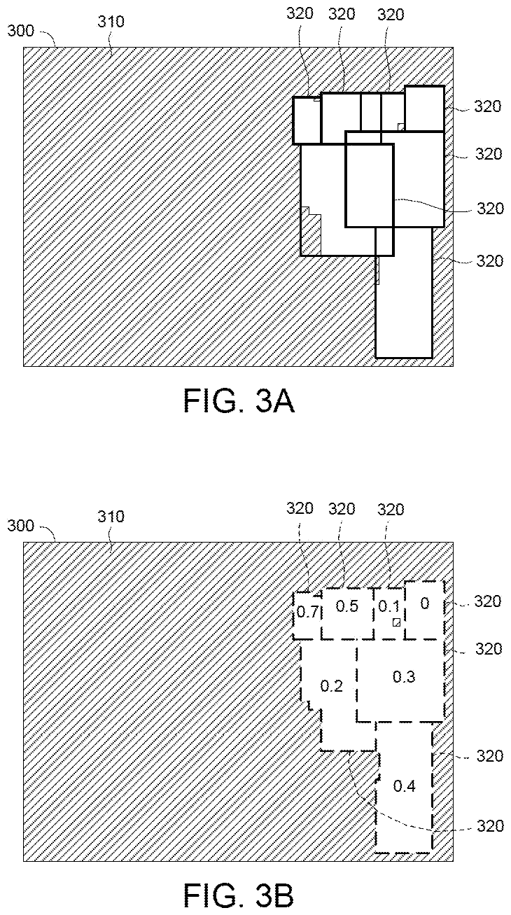

FIG. 3A shows initial placement of bounding boxes according to one embodiment of the application. Details of how to place the bounding boxes are not specified here. FIG. 3B shows obtained block shapes from the block shaping according one embodiment of the application, where the values in blocks represent the difference (%) in area from the requirements.

FIG. 3A and FIG. 3B illustrate the results of a design case with limited white space 310 (having the blockages) in the chip canvas 300. In FIG. 3A, the BBoxes 320 acquired from RL are displayed, with BBoxes 320 overlapping each other and blockages.

After block shaping, FIG. 3B shows the shaped blocks 330, which are in the form of rectilinear with no zig-zag edges, making the shaped blocks 330 more suitable for practical implementations. The values in the shaped blocks 330 are the area difference ratio “[(Âₘ*−Âₘ*)/Aₘ*]*100%”. If the area difference ratio “[(Âₘ−Aₘ*)/Aₘ*]*100%” is between ±1%, then the obtained non-overlapping area Âₘ is acceptable. As shown in FIG. 3B, the values in the shaped blocks 330 are between 0-0.7%, which are all acceptable. Also, the shaped blocks 330 are non-overlapped with each other; and the shaped blocks 330 are non-overlapped with the blockages.

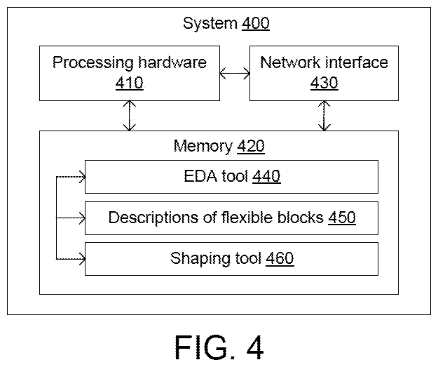

FIG. 4 is a block diagram illustrating a system 400 operative to perform flexible block shaping according to one embodiment. System 400 includes processing hardware 410, a memory 420, and a network interface 430. In one embodiment, processing hardware 410 may include one or more processors and accelerators, such as one or more of: a central processing unit (CPU), a GPU, a digital processing unit (DSP), an AI processor, a tensor processor, a neural processor, a multimedia processor, other general-purpose and/or special-purpose processing circuitry.

System 400 further includes memory 420 coupled to processing hardware 410. Memory 420 may include memory devices such as dynamic random access memory (DRAM), SRAM, flash memory, and other non-transitory machine-readable storage media; e.g., volatile or non-volatile memory devices. Memory 420 may further include storage devices, for example, any type of solid-state or magnetic storage device. In one embodiment, memory 420 may store one or more EDA tools 440 and a shaping tool 460 for placing flexible blocks. The shaping tool 460 may include one or more neural networks, AI agents, an RL agent (e.g., RL agent 110 in FIG. 1), an environment (e.g., environment 120 in FIG. 1) that interacts with the RL agent. Memory 420 may further store descriptions of flexible blocks 450 to be shaped on a chip canvas. In some embodiments, memory 420 may store instructions which, when executed by processing hardware 410, cause the processing hardware to perform the aforementioned methods and operations for flexible block shaping and/or for training a neural network to perform flexible block shaping.

In some embodiments, system 400 may also include a network interface 430 to connect to a wired and/or wireless network. It is understood the embodiment of FIG. 4 is simplified for illustration purposes. Additional hardware components may be included.

The operations of the flow diagram of FIG. 2 have been described with reference to the exemplary embodiment of FIG. 4. However, it should be understood that the operations of the flow diagram of FIG. 2 can be performed by embodiments of the invention other than the embodiment of FIG. 4, and the embodiment of FIG. 4 can perform operations different than those discussed with reference to the flow diagram. While the flow diagram of FIG. 2 shows a particular order of operations performed by certain embodiments of the invention, it should be understood that such order is exemplary (e.g., alternative embodiments may perform the operations in a different order, combine certain operations, overlap certain operations, etc.).

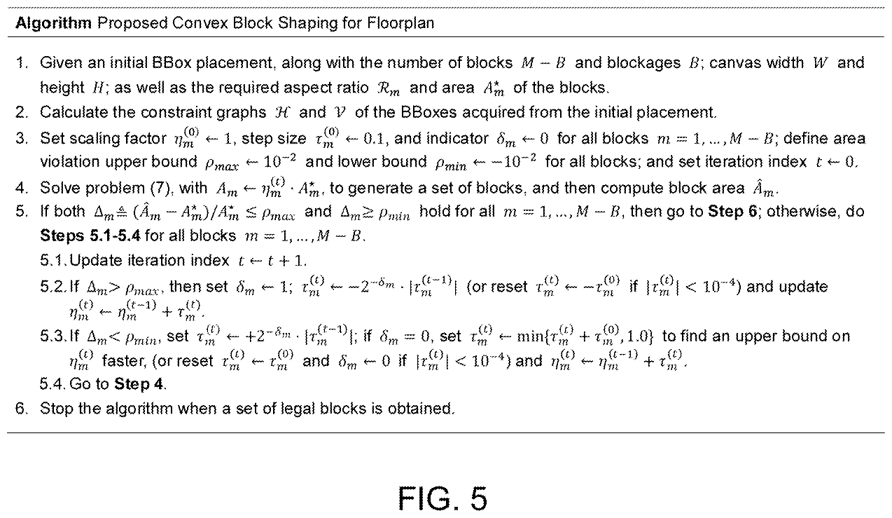

FIG. 5 shows an example of convex block shaping for floorplan algorithm according to one embodiment of the application. Details of FIG. 5 may be referred to above description and thus is not repeated here.

The wire length from the block-shaped placement using both the proposed block shaping method and a commercial EDA tool are compared in Table I. The wire length is calculated using a proprietary tool. Additionally, the runtime for the 8 design cases are presented in Table II. This was done using a server PC with 2.7 GHz CPU and 16 GB RAM. The results show that the proposed block shaping method is able to achieve shorter wire length and faster runtime.

TABLE I
WIRE LENGTH (×10⁶ μm) COMPARISONS OF
PROPOSED METHOD AND COMMERCIAL EDA TOOL

| | Case 1 | Case 2 | Case 3 | Case 4 | Case 5 | Case 6 | Case 7 | Case 8 |
|---|---|---|---|---|---|---|---|---|
| Proposed Method | 85.11 | 81.49 | 261.30 | 123.29 | 81.24 | 351.97 | 544.30 | 504.19 |
| Commercial EDA Tool | 86.08 | 81.14 | 765.45 | 130.81 | 82.63 | 358.37 | 2233.03 | 561.82 |

TABLE II
RUNTIME (SECONDS) COMPARISONS OF PROPOSED
METHOD AND COMMERCIAL EDA TOOL

| | Case 1 | Case 2 | Case 3 | Case 4 | Case 5 | Case 6 | Case 7 | Case 8 |
|---|---|---|---|---|---|---|---|---|
| Proposed Method | 396 | 198 | 180 | 448 | 483 | 616 | 1140 | 1335 |
| Commercial EDA Tool | 8565 | 7916 | 5637 | 1163 | 5795 | 4579 | 23093 | 21650 |

Block shaping is an essential factor for the modern, fixed-outline floorplan, as it can heavily impact the performance of subsequent processes. In implementation, a canvas usually contains pre-placed blocks and blockages, with fixed locations. This means that the space available for accommodating flexible blocks is limited, making block shaping difficult to manage. To address this issue, one embodiment of the application discloses the block shaping design and proposes an analytical solution. Specifically, an iterative convex optimization is proposed for bounding box updates, as well as overlapping area allocation. One embodiment of the application can effectively deal with the block shaping problem. Also, experiment results show that the proposed method is more time-efficient than commercial EDA tools, and can generate high-performance block shapes.

Various functional components or blocks have been described herein. As will be appreciated by persons skilled in the art, the functional blocks will preferably be implemented through circuits (either dedicated circuits or general-purpose circuits, which operate under the control of one or more processors and coded instructions), which will typically comprise transistors that are configured in such a way as to control the operation of the circuitry in accordance with the functions and operations described herein.

While this document may describe many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination in some cases can be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

What is claimed is:

1. A method of shaping flexible blocks on a chip canvas in an integrated circuit (IC) design, comprising:
receiving an input describing geometric features of a plurality of flexible blocks to be shaped on the chip canvas;
generating a set of flexible blocks based on the input, and computing a plurality of obtained block areas of the set of flexible blocks;
determining whether the set of flexible blocks are legal based on determining whether a plurality of area differences between the plurality of obtained block areas and a plurality of required areas for the set of flexible blocks meet a requirement; and
when the set of flexible blocks are not all legal, updating the set of flexible blocks until the set of flexible blocks are all legal.

2. The method according to claim 1, wherein in determining whether the set of flexible blocks are legal,
when determining that the plurality of area differences are smaller than an area violation upper bound but larger than an area violation lower bound, determining that the set of flexible blocks are all legal.

3. The method according to claim 2, wherein the step of updating the set of flexible blocks includes:
updating an iteration index;
when the area difference of the flexible block is larger than the area violation upper bound, setting an indicator, updating or resetting a step size, and updating a scaling factor to update the flexible block; and
when the area difference of the flexible block is smaller than the area violation lower bound, setting the indicator, updating or resetting the step size, and updating the scaling factor to update the flexible block.

4. The method according to claim 1, wherein the flexible block that fulfills the following criteria: (i) non-overlapping; (ii) meeting required block area; (iii) adhering to a specified aspect ratio; (iv) forming a connected block region; and (v) exhibiting a rectangle-like shape without zig-zag edges is referred as legal.

5. The method according to claim 1, wherein the step of generating the set of the flexible blocks includes:
constraining a first center coordinate of a bounding box based on a width of the bounding box and a canvas width of the chip canvas; and
constraining a second center coordinate of the bounding box based on a height of the bounding box and a canvas height of the chip canvas,
wherein the bounding box is constrained to be located within the chip canvas.

6. The method according to claim 1, wherein the step of generating the set of the flexible blocks includes:
specifying overlapping constraints of a plurality of bounding boxes by constraining differences between a plurality of first center coordinates of the bounding boxes based on widths of the bounding boxes and first overlapping quantities and constraining differences between a plurality of second center coordinates of the bounding boxes based on heights of the bounding boxes and second overlapping quantities.

7. The method according to claim 1, wherein the step of generating the set of the flexible blocks includes:
constraining an aspect ratio and an area of a bounding box by constraining the aspect ratio of the bounding box within a predetermined range.

8. The method according to claim 1, wherein the step of generating the set of the flexible blocks includes:
constraining a height and a width of a bounding box to be larger than 0.

9. The method according to claim 1, wherein the step of generating the set of the flexible blocks includes:
constraining half-perimeter wire length (HPWL) of a plurality of bounding boxes.

10. The method according to claim 1, wherein the geometric features of the plurality of flexible blocks include a given bounding box placement, a block number of the flexible blocks or a blockage number of a plurality of blockages, a canvas width and a canvas height of the chip canvas, required aspect ratios and required areas of the flexible blocks.

11. A system for shaping flexible blocks on a chip canvas in an integrated circuit (IC) design, the system comprising:
memory to store descriptions of the flexible blocks; and
one or more processors coupled to the memory, at least one of the processors operative to perform operations of a neural network, wherein the one or more processors are operative for:
receiving an input describing geometric features of a plurality of flexible blocks to be shaped on the chip canvas;
generating a set of flexible blocks based on the input, and computing a plurality of obtained block areas of the set of flexible blocks;
determining whether the set of flexible blocks are legal based on determining whether a plurality of area differences between the plurality of obtained block areas and a plurality of required areas for the set of flexible blocks meet a requirement; and
when the set of flexible blocks are not all legal, updating the set of flexible blocks until the set of flexible blocks are all legal.

12. The system of claim 11, wherein the one or more processors are further operative for:
in determining whether the set of flexible blocks are legal,
when determining that the plurality of area differences are smaller than an area violation upper bound but larger than an area violation lower bound, determining that the set of flexible blocks are all legal.

13. The system of claim 12, wherein the one or more processors are further operative for:
in updating the set of flexible blocks,
updating an iteration index;
when the area difference of the flexible block is larger than the area violation upper bound, setting an indicator, updating or resetting a step size, and updating a scaling factor to update the flexible block; and
when the area difference of the flexible block is smaller than the area violation lower bound, setting the indicator, updating or resetting the step size, and updating the scaling factor to update the flexible block.

14. The system of claim 11, wherein the one or more processors are further operative for:
determining the flexible block is legal when the flexible block fulfills the following criteria: (i) non-overlapping; (ii) meeting required block area; (iii) adhering to a specified aspect ratio; (iv) forming a connected block region; and (v) exhibiting a rectangle-like shape without zig-zag edges.

15. The system of claim 11, wherein the one or more processors are further operative for:
generating the set of the flexible blocks includes:
constraining a first center coordinate of a bounding box based on a width of the bounding box and a canvas width of the chip canvas; and
constraining a second center coordinate of the bounding box based on a height of the bounding box and a canvas height of the chip canvas,
wherein the bounding box is constrained to be located within the chip canvas.

16. The system of claim 11, wherein the one or more processors are further operative for:
generating the set of the flexible blocks includes:
specifying overlapping constraints of a plurality of bounding boxes by constraining differences between a plurality of first center coordinates of the bounding boxes based on widths of the bounding boxes and first overlapping quantities and constraining differences between a plurality of second center coordinates of the bounding boxes based on heights of the bounding boxes and second overlapping quantities.

17. The system of claim 11, wherein the one or more processors are further operative for:
generating the set of the flexible blocks includes:
constraining an aspect ratio and an area of a bounding box by constraining the aspect ratio of the bounding box within a predetermined range.

18. The system of claim 11, wherein the one or more processors are further operative for:
generating the set of the flexible blocks includes:
constraining a height and a width of a bounding box to be larger than 0.

19. The system of claim 11, wherein the one or more processors are further operative for:
generating the set of the flexible blocks includes:
constraining half-perimeter wire length (HPWL) of a plurality of bounding boxes.

20. The system of claim 11, wherein the geometric features of the plurality of flexible blocks include a given bounding box placement, a block number of the flexible blocks or a blockage number of a plurality of blockages, a canvas width and a canvas height of the chip canvas, required aspect ratios and required areas of the flexible blocks.
